(19) United States
(12) Patent Application Publication
(10) Pub. No.: US 2022/0039316 A1
(43) Pub. Date: Feb. 10, 2022

(54) AUTOMATED HEMP TRIMMING SYSTEM AND METHOD

(71) Applicant: Samson Seidel, Oroville, CA (US)

(72) Inventor: Samson Seidel, Oroville, CA (US)

(21) Appl. No.: 17/398,962

(22) Filed: Aug. 10, 2021

Related U.S. Application Data
(60) Provisional application No. 63/063,876, filed on Aug. 10, 2020.

(51) Int. Cl. A01D 41/12; A01D 61/02; A01D 45/00

(52) U.S. Cl. CPC A01D 41/12; A01D 45/00; A01D 61/02

(57) ABSTRACT

An industrial hemp trimming apparatus and system which features rotating drums configured to actuate angularly to facilitate the fine tuning of precise flower trim setting is described. At least one motor disposed in communication with a control station and drive shaft via at least one drive chain facilitates rotation of the drum(s) against a cutting surface. The control station, managed by an Arduino, enables manipulation of spin speed, spin duration, and articulation of the drums to fine-tune the trimming of the hemp flower in accordance with strain-specific characteristics. Each drum is equipped with staggered, evenly spaced cutouts configured to line up with similarly arranged cutouts of the stationary cutting surface, by which flower is trimmed as the drum(s) rotate.

### CONTINUITY

This application is a non-provisional application of provisional patent application No. 63/063,876, filed on Aug. 10, 2020, and priority is claimed thereto.

### FIELD OF THE PRESENT INVENTION

The present invention relates to the field of agricultural cultivation mechanisms, and more specifically relates to a system and method of mechanically trimming hemp flower of stems while maximizing production volume and minimizing waste via daisy-chained rotary cutters.

### BACKGROUND OF THE PRESENT INVENTION

Hemp cultivation is increasingly a lucrative crop as legislation has broadly passed to permit such cultivation in many states and countries. It is known that a variety of different strains of cannabis flower may be grown to address a wide range of medical and recreational purposes. For industrial applications, as well as for retail sale recreationally and medicinally, flower must be trimmed to minimize waste as it is sold by weight.

Unfortunately, the trimming process is conventionally labor intensive and until recently has primarily been performed manually. This is an arduous task which causes hand strain and is also fairly messy due to the stickiness of the flower. Even with a large team of individuals, working in shifts, it can take quite some time to harvest and trim a crop. If there were a way in which this process could be performed accurately and correctly with a machine, profits could be maximized and labor-intensive work could be reduced.

Thus, there is a need for a new type of agricultural machinery system and method configured to expedite and facilitate the trimming of hemp flower such that it is suitable for retail sale. Such a system can preferably handle a high capacity of flower simultaneously, while being a scalable solution which minimizes the manual labor involved in the grow operation. Such a system may preferably automated, and may be customized to the benefit of the specific strain of crop trimmed.

Some mechanical trimming systems and solutions have been introduced to the industry which do help to alleviate some of the manual labor involved in the trimming process. However, all industrial trimming machine systems presently available on the market are aggressive, and average 35 to 40% waste, drastically decreasing the overall profitable yield of the cultivated product. In contrast, the system of the present invention minimizes waste down to 11 to 14%, substantially increasing the profit of the operation. Additionally, existing trimming solutions do not provide adequate articulation and speed compensation to facilitate the needed efficiency and efficacy of the present invention.

### SUMMARY OF THE PRESENT INVENTION

The present invention is an industrial trimming machine system and method configured to expedite and facilitate the trimming of hemp flower. The system employs at least one drum equipped with slots which are staggered around the entirety of the at least one drum. The drum is configured to rotate against a static cutter via connection to at least one motor. The at least one drum is configured to articulate such that the drums may rotate within a 90-degree horizontal to 45-degree diagonal angle as needed. Rotation speed and articulation is preferably programmed via at least one PLC and/or arduino which enables the system to be custom tailored to the strain trimmed via the system. A conveyor belt, disposed beneath the at least one drum facilitates emptying of the drums after the trimming process is complete. Dust is captured via suction, and waste clippings are preferably secured for other uses.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the apparatus of the present invention as seen from the front.

FIG. 2 depicts a close-up view of the drum and cutouts of the present invention as seen from the side.

FIG. 3 shows a flow chart detailing the process of use of the present invention by a user.

FIG. 4A shows a schematic of the trammel system of the present invention from the front, depicting the drums within the trammel having differing sized flower isolation mechanisms.

FIG. 4B shows a schematic of the trammel system of the present invention as depicted from the side, detailing the drums, funnel, and flower receptacles.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is an industrial trimming apparatus and system configured to trim hemp flower in volumes while maintaining quality. The system and apparatus enables one to retain an incredible and gently trimmed product as a result which minimizes trim waste to maximize sale value.

The preferred embodiment of the present invention includes at least one drum (10), a frame (20), at least one motor (30), a power source (40), at least one drive chain (50), at least one drive shaft (60), a cutting surface (70), and a control station (80). The at least one motor (30) is disposed in communication with the at least one drum (10) via the drive shaft (60) and at least one drive chain (50). Two pillow block bearings are disposed in communication with the drive shaft (60) and the frame (20) structure of the apparatus, facilitating the rotation of the at least one drum (10). The at least one motor (30) is preferably connected to the power source (40) and the control station (80) via at least one wire (110).

At least one actuator (100), preferably disposed in communication with a hydraulic shaft, is configured to facilitate the actuation of the drive shaft (60) and drum (10) to provide additional versatility to the system. Via the at least one actuator (100), the drum (10) may be oriented such that it rotates about a horizontal plane such that the drive shaft (60) and drum (10) are disposed horizontally, or may be actuated such that the drive shaft (60) and drum (10) are disposed diagonally or even vertically if desired. It is envisioned that the at least one actuator (100) preferably facilitates a range of actuation angles up to, and/or including 0 to 90 degrees. The at least one actuator (100) is preferably disposed in communication with the power source (40) and the control station (80) via at least one wire (110).

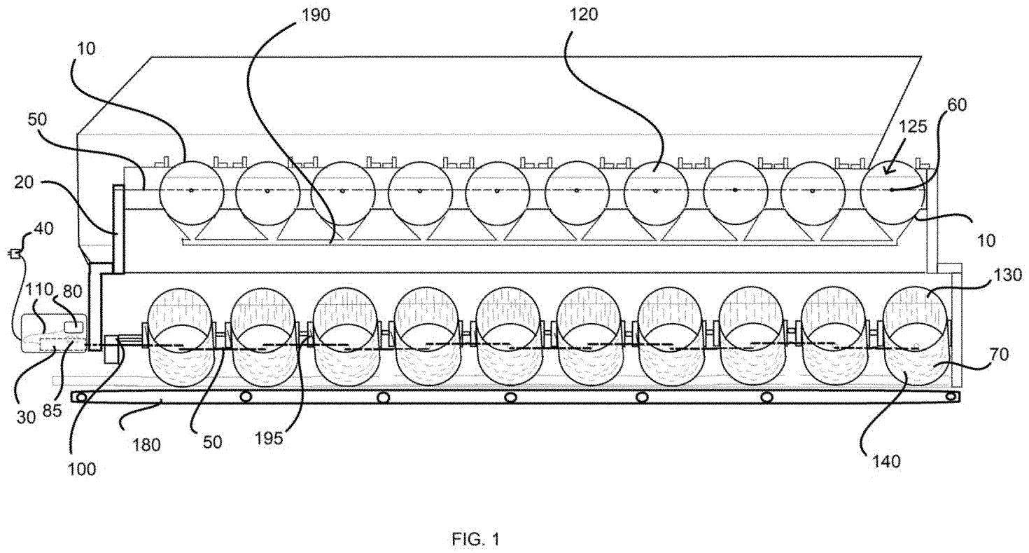

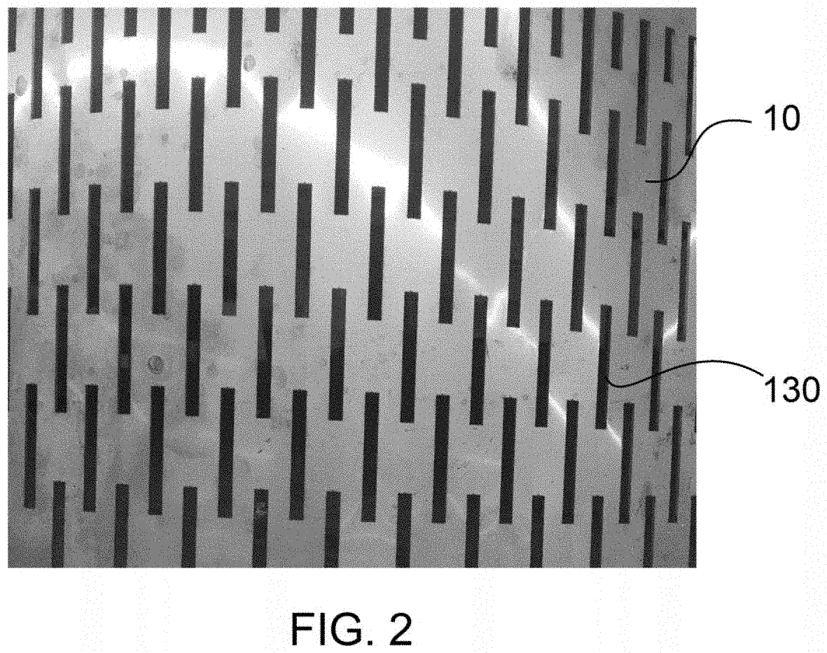

Each iteration of the at least one drum (10) of the present invention is preferably equipped with a door (120) which is preferably magnetically attached to a front (125) of each drum (10). The door (120) is ideally a ⅔ door having two sections, one taking up approximately ⅓^{rd} of the area of the front (125) and a second section taking up approximately ⅔^{rd} of the front (125) as shown in FIG. 1. It is envisioned that both sections of the door (120) may be opened, together or independently as needed, and that the entirety of the door (120) may be removed as needed for product retrieval and product loading. The doors (120) are preferably made from food grade components including 304 stainless steel, aluminum, and/or clear plexiglass. Preferred embodiments employ 304 stainless steel for door construction. The segmented doors (120) enable one to open only a portion of the door (120) to check on the status of the product without spilling the product even when the drum (10) is horizontal.

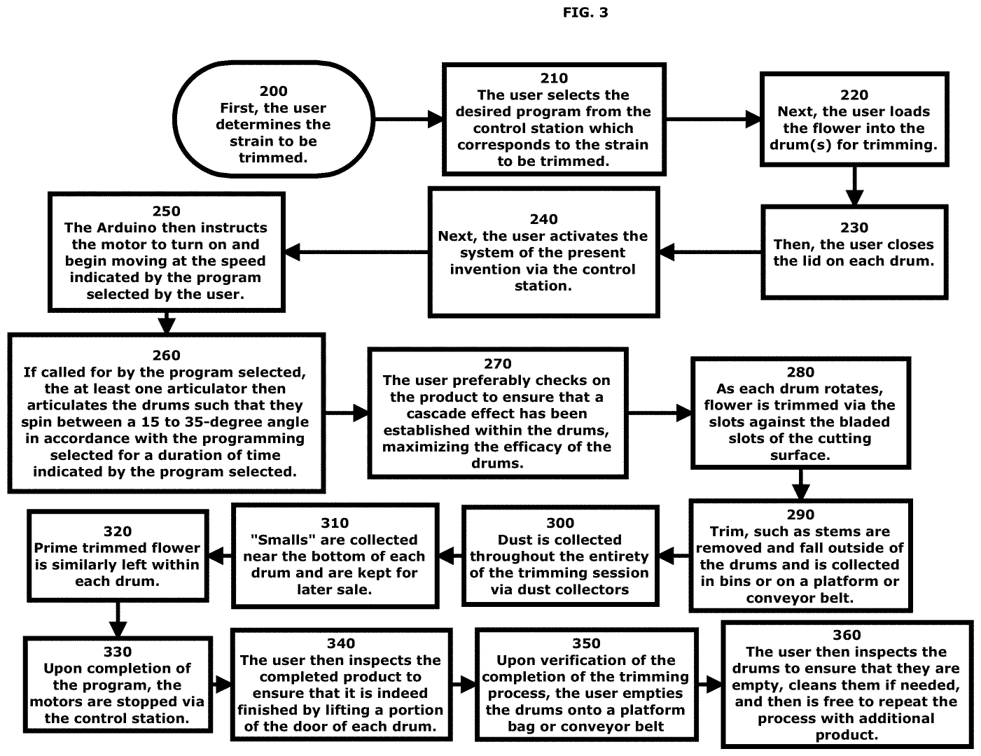

Each iteration of the at least one drum (10) is equipped with slots (130) which are staggered in placement as shown in FIG. 3, and are present around the entirety of the circumference of the cylinder that is each drum (10). The slots (130) are preferably 3/16 inches by 2 inches, and are preferably staggered by 0.25 inches; however, alternate embodiments of the present invention may employ differently sized slots (130), and may be staggered differently as needed. Each iteration of the at least one drum (10) is preferably 60 inches in circumference, with a total of four to five feet (approximately 42 inches) of cutter, evidenced by the slots (130) per inch of width of each drum (10). Corresponding to the slots (130) of the drum(s) (10), the cutting surface (70) is equipped with bladed slots (140) which are preferably disposed at a 31.5 degree angle to mimic the cutting angle of conventional scissors when against the slots (130) of the drum (10). The bladed slots (140) are preferably present across the entirety of the cutting surface (70), which amounts to a semi-circle configured to securely rest in communication with a bottom portion (135) of the drum (10), and are mounted to the frame (20) of the apparatus via J-hooks (145). Springs (155) disposed in communication with the frame (20) and the J-hooks (145) ensure that the cutting surface (70) maintains adequate tension against the drum (10) to facilitate clean cuts of the flower.

The control station (80) of the present invention is preferably managed via an Arduino, and is equipped with tangible controls (85) configured to facilitate the manipulation of the speed of rotation of the at least one motor (30) to influence of the rotation speed of the drum(s) (10), as well as to manipulate the rotation time of the drum(s) (10). The control station (80) is also configured to control the at least one articulator (100). The at least one articulator (100) is preferably a 12 v linear articulator which is configured to pivot the at least one drum (10), including the drive shaft (60) up to, or surpassing a 45-degree angle. Articulation of the drum(s) (10) via the at least one articulator (100) is critical in obtaining and maintaining a ‘cascade effect’ within each iteration of the at least one drum (10) such that the flower within each drum (10) is cut gently and accurately by the cutting surface (70) of the present invention. As each iteration of the at least one drum (10) is articulated, critical cutting points of the cutting surface (70) emerge at approximately four and nine o'clock. Flower of the hemp plant is rolled around in each drum (10), at which time the cutting surface (70) cuts off trim elements such as crows feet and the final stem, leaving solely the flower and node or cone as applicable. Each iteration of the at least one drum (10), functioning in tandem with the cutting surface (70) is configured to minimize any rounding off of the flower, and saves all small pieces, down to approximately the size of a “BB” in order to achieve minimal loss to waste.

The drive chain (50) is preferably disposed in communication with sprockets (75) of each iteration of drive shaft (60), and is configured to drive each iteration of the at least one drum (10) per the at least one motor (30) and the rigidity of the frame (20). As such, the frame (20) is preferably structurally welded together with ample support beams to facilitate secure and stable use of the at least one motor (30) without failing. The at least one motor (30) is preferably configured to be powered via a 220 V power source. Additionally, the at least one motor (30) is preferably a 2 HP motor which is capable of rotating up to nine drums (10) at the adequate speed and power necessary to perform the trimming process. It is envisioned that a minimum of 500 in/lb of torque is available per drum to achieve the desired result. In such embodiments in which the at least one motor (30) is powering the rotation of multiple drums (10), the drive chain(s) (50) are preferably daisy-chained together as shown in FIG. 1.

The preferred embodiment of the present invention is preferably configured to capture and retain any and all dust produced via the trimming executed by the system via a conventional dust collector (190) to facilitate sale of the dust (kief) as desired. Additionally, all small trimmings (referenced as ‘smalls’) are generally dropped to the bottom of each drum (10) as they are articulated about the at least one articulator (100) towards a vertical plane per granular convection (Brazil nut effect). Waste is minimized as trimmings cut from the final product may also be saved per containers disposed beneath each iteration of the at least one drum (10). Similarly, a large, bag-like platform may be positioned under the entirety of the system to catch any and all trim which may be used for non-primary purposes. A conveyor belt (180) may be employed to facilitate catching and retrieval of pieces cut, as well as to facilitate the emptying of the product from the drum(s) (10) upon completion of the trimming session.

Overall, the system is geared to minimize waste such that a mere 11 to 14% of the flower product is relegated to ‘smalls’ or trim, generally known to be worth much less than the primary trimmed product achieved by the present invention. As a result, the system of the present invention produces a much greater profitable yield than any competing trimming system available.

The process of use of the system and apparatus of the present invention, as shown in FIG. 3, is preferably as follows:
1. First, the user determines the strain to be trimmed. (200)
2. The user selects the desired program from the control station which corresponds to the strain to be trimmed. (210)
3. Next, the user loads the flower into the drum(s) for trimming. (220) It should be noted that the flower should be pre-trimmed from off of the hemp plants first and left to dry for the recommended amount of time prior to placing the flower into the drums.
4. Then, the user closes the lid on each drum. (230)
5. Next, the user activates the system of the present invention via the control station. (240)
6. The Arduino then instructs the motor to turn on and begin moving at the speed indicated by the program selected by the user. (250) it should be noted that the duration of time at which the drum(s) are rotated at this speed varies in accordance with the program selected as well.
7. If called for by the program selected, the at least one articulator then articulates the drums such that they spin between a 15 to 35-degree angle at a consistent RPM in accordance with the programming selected for a duration of time indicated by the program selected. (260)
8. The user preferably checks on the product to ensure that a cascade effect has been established within the drums, maximizing the efficacy of the drums. (270)
9. As each drum rotates, flower is trimmed via the slots against the bladed slots of the cutting surface. (280)
10. Trim, such as stems are removed and fall outside of the drums and is collected in bins or on a platform or conveyor belt. (290)
11. Dust is collected throughout the entirety of the trimming session via dust collectors (300)
12. “Smalls” are collected near the bottom of each drum and are kept for later sale. (310)
13. Prime trimmed flower is similarly left within each drum. (320)
14. Upon completion of the program, the motors are stopped via the control station. (330)
15. The user then inspects the completed product to ensure that it is indeed finished by lifting a portion of the door of each drum. (340)
16. Upon verification of the completion of the trimming process, the user empties the drums onto a platform bag or conveyor belt. (350)
17. The user then inspects the drums to ensure that they are empty, cleans them if needed, and then is free to repeat the process with additional product. (360)

It should be noted that loading cans may be employed to facilitate the loading of multiple iterations of the at least one drum (10) simultaneously to speed up use of the system and apparatus of the present invention. With such loading cans, the cams are pre-loaded away from the apparatus and then slid in front of the series of drums (10), then tipped and the product is loaded into multiple drums (10) simultaneously.

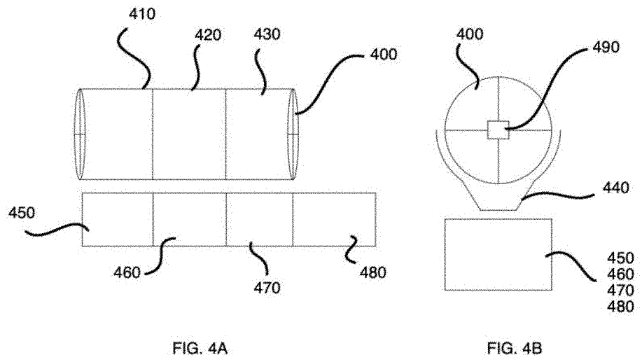

As shown in FIG. 4A and FIG. 4B, it should be noted that the preferred embodiment of the present invention employs a sorting trammel system (400) which is placed at the exit of the conveyor system of the apparatus, which continues the operation of the system beyond step 17 as listed above. The trammel system (400) is configured to revolve around at adjusted angles and speeds to control the feed rate. As the trammel revolves, it allows the particular sizing of the trimmed flower to be easily categorized by size automatically. The trammel system (400) is preferably equipped with three different sizes: 0.5 inch expanded stainless holes, 1 inch expanded stainless holes, and 1.5 inch expanded stainless holes. The aforementioned holes are present within three differently sized stations: a first station (410), a second station (420), and a third station (430). A funnel (440) disposed beneath said trammel (400) is configured to catch and focus falling hemp flower into three receptacles disposed beneath the funnel (440): a first receptacle (450) configured to capture flower ½ inch and under in size, a second receptacle (460) configured to capture flower ½ in to 1 in in size, and a third receptacle (470) configured to capture flower between 1 inch and 1.5 inches in size. A fourth receptacle (480) may also be present to capture flower that is greater than 1.5 inches in size which does not fall through the trammel (400), but instead passes through the entire length of the trammel (400) due to it being too large to fall through the holes. A trammel motor (490) facilitates rotation of said trammel system (400) and is preferably powered via the power source (40).

It should additionally be noted that the entire apparatus of the present invention, at present, is adaptable and scalable such that it may be completed housed and executed within a box truck, tractor-trailer, or similar mobile unit with ease. However, it should be understood that this need not be a limiting factor to the potential uses of the system and apparatus of the present invention, and that it may be tailored for use within a more permanent structure if desired.

Each iteration or installation of the system of the present invention is preferably equipped with four to eight feet of washdown grade LED lights disposed on the ceiling. Additionally, a 12 v off-road styled light bar may be disposed above the doorway adjacent to the installation to facilitate view of the operation. It should be understood that the system of the present invention is configured to provide audio/visual signals relating to the timing of each trimming session which functions in coordination with a timer for the trimming session. It should be noted that the motor may be configured to run in the opposite direction via a switch if desired. Users may also install or make their own programs tailored to the specific strain if needed or desired.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A hemp flower trimming system comprising:
a frame;
at least one drum, said at least one drum supported by said frame;
at least one motor;
a power source, said power source in communication with said at least one motor;
a control station, said control station disposed in communication with said power source and said at least one motor;
a drive shaft, said drive shaft disposed in communication with said at least one motor;
at least one drive chain, said at least one drive chain disposed in communication within said drive shaft;
wherein said drive shaft is supported by said frame;
two pillow block bearings, said two pillow block bearings disposed in communication with said drive shaft and said frame;
cutting surfaces, said cutting surfaces disposed adjacent to and in communication with an exterior of said at least one drum; and
slots, said slots present in a staggered and patterned placement around said at least one drum, permeating through to said exterior of said at least one drum.

2. The apparatus of claim 1, further comprising:
J-hooks, said J-hooks supporting said cutting surface against said exterior of said at least one drum, maintaining tension against said exterior of said at least one drum; and
wherein said J-hooks are disposed in communication with said frame.

3. The apparatus of claim 1, further comprising:
at least one actuator, said at least one actuator disposed in communication with a hydraulic shaft;
wherein said at least one actuator facilitates actuation of said drive shaft and said at least one drum such that said at least one drum may be rotated about a horizontal plane or a diagonal plane;

4. The apparatus of claim 3, wherein said at least one actuator facilitates a range of actuation angles between zero and 90 degrees; and
wherein said at least one actuator is dispose din communication with said power source and said control station.

5. The apparatus of claim 1, further comprising:
doors, said doors disposed on said at least one drum; and
wherein said doors are magnetically affixed to said at least one drum.

6. The apparatus of claim 5, wherein said doors are equipped with two sections: a first section covering ⅓ of a diameter of said at least one drum, and a second covering ⅔ of said diameter of said at least one drum.

7. The apparatus of claim 5, wherein said doors are composed of at least one of the following: 304 stainless steel, aluminum, and clear plexiglass.

8. The apparatus of claim 4, wherein said control station is configured to control said at least one articulator and speed of rotation of said at least one motor, affecting the speed of rotation and disposition of said at least one drum.

9. The apparatus of claim 1, wherein said motor is a 2 HP motor.

10. The apparatus of claim 1, wherein said motor is configured to provide a minimum of 500 in/lb of torque to each of said at least one drum.

11. The apparatus of claim 1, further comprising:
a conveyor belt, said conveyor belt disposed beneath said at least one drum; and
wherein said conveyor belt is configured to convey the hemp flower to a revolving sorting trammel.

12. The apparatus of claim 11, wherein said revolving sorting trammel isolates hemp flower via differently sized stations according to sizes as trimmed by said cutting surface acting against said slots of said at least one drum, the sizes selected from the following group: ½ inch sized flower isolated via a first station, 1 inch sized flower isolated via a second station, and 1.5 inch flower isolated via a third station.

13. The apparatus of claim 12, further comprising:
a funnel said funnel disposed beneath said sorting trammel; and
wherein said funnel is configured to deposit sorted hemp flower into at least three receptacles, said at least three receptacles selected from the following group: a first receptacle configured to catch ½ inch sized flower, a second receptacle configured to catch 1 inch sized flower, and a third receptacle configured to catch 1.5 inch sized flower.

14. The apparatus of claim 4, further comprising:
doors, said doors disposed on said at least one drum; and
wherein said doors are magnetically affixed to said at least one drum.

15. The apparatus of claim 14, further comprising:
a conveyor belt, said conveyor belt disposed beneath said at least one drum; and
wherein said conveyor belt is configured to convey the hemp flower to a revolving sorting trammel.

16. The apparatus of claim 15, wherein said revolving sorting trammel isolates hemp flower via differently sized stations according to sizes as trimmed by said cutting surface acting against said slots of said at least one drum, the sizes selected from the following group: ½ inch sized flower isolated via a first station, 1 inch sized flower isolated via a second station, and 1.5 inch flower isolated via a third station.

17. The apparatus of claim 16, further comprising:
a funnel said funnel disposed beneath said sorting trammel; and
wherein said funnel is configured to deposit sorted hemp flower into at least three receptacles, said at least three receptacles selected from the following group: a first receptacle configured to catch ½ inch sized flower, a second receptacle configured to catch 1 inch sized flower, and a third receptacle configured to catch 1.5 inch sized flower.

18. The apparatus of claim 17, further comprising:
a trammel motor, said trammel motor disposed in communication with said revolving sorting trammel and said power source, facilitating rotation of said revolving sorting trammel.
